(19) United States
(12) Patent Application Publication
(10) Pub. No.: US 2021/0326228 A1
(43) Pub. Date: Oct. 21, 2021

(54) SYSTEM TESTING METHOD AND SYSTEM TEST KIT

(71) Applicant: VESTEL ELEKTRONIK SANAYI VE TICARET A.S., Manisa (TR)

(72) Inventors: Duygu METIN, Manisa (TR); Ceren SAHIN GEBIZLI, Manisa (TR)

(21) Appl. No.: 16/338,914

(22) PCT Filed: Nov. 17, 2016
(86) PCT No.: PCT/EP2016/077927

§ 371 Date: Apr. 2, 2019

(51) Int. Cl. G06F 11/27; G06F 17/18

(52) U.S. Cl. CPC G06F 11/27; G06F 17/18

(57) ABSTRACT

The present invention provides a method of testing a system (101), such as a computer program, system or software which is embedded in an electronic device as firmware. The method at least comprises creating a model of the system under test, performing static code analysis on the system to generate one or more alerts (103), each respectively indicative of a respective error in the system under test, using the alerts to adapt the model (105) of the system, using the adapted model of the system to generate a test suite (107), and executing the test suite thus generated on the system under test. The present invention also provides a corresponding test kit comprising a static code analysis tool and a model-based testing tool, wherein the model-based testing tool uses results generated by the static code analysis tool. This system testing method and test kit have the advantage of allowing a part or parts of the system under test which require more testing than others to be identified by the static code analysis, and for the execution of the test suite on the system to be concentrated on those parts of the system more than on the others. Thus, the chance of exposing any faults, bugs or errors in the system can be increased, whilst the length of the test cycle can be reduced.

The present invention relates to a method of testing a system according to claim 1, a system test kit according to claim 8, an electronic device according to claim 10 or claim 11, a method of manufacturing an electronic device according to claim 13, and a computer program product or a program code or system according to claim 14 or

### BACKGROUND OF THE INVENTION

Consumer demand for new electronic devices means that consumers desire each new generation of technology in the shortest time possible, at the least possible cost and with the fewest possible bugs or errors in any computer program, system or software which is embedded in such devices (hereinafter simply referred to as “device software”). Such device software is often referred to as firmware. This puts pressure on the manufacturers of electronic devices to produce each new generation of device software as quickly as possible, whilst maintaining its reliability. This has led such manufacturers to develop “agile” methods of producing device software, instead of traditional methods. In agile methods, rather than releasing a final version of a device's software at one time, new iterations of the device software are continuously released, adding new features and refining the end-user's experience. As the device software is altered, the emergence of new faults, bugs or errors and/or the re-emergence of old faults or errors are quite common. Consequently, regression testing has to be carried out on each newly released version. Regression testing is so called because it checks whether the latest version of the device software has regressed to a condition in which it exhibits more and/or new errors than the previous, unrevised version. The purpose of regression testing is to identify and permit the correction of any such faults or errors. For the minimum number of errors, it would be desirable to carry out detailed testing of the device software over more than one test cycle. On the other hand, even only a single test cycle of the device software for a complex system, such as a television, requires a considerable period of time. This has led to the development of new techniques of effective test design, which aim to shorten the test cycle, without decreasing the test quality.

One known technique is to carry out static code analysis of computer program code in order to identify errors in the code. Static code analysis is the analysis of computer program code without execution of the code. In contrast, dynamic code analysis is the analysis of computer program code by executing the code on a real or virtual processor. In static code analysis, the analysis can be carried out by a testing tool, which is able to generate one or more alerts, each of which is indicative of an error in the code being tested.

Model-based testing is another way of testing a computer program or system, which creates a model of the system under test (SUT). The model is an abstract representation of the desired, intended or predicted operation of the SUT. In model-based testing, the model is used to create one or more test scenarios at the same level of abstraction as the model. These test scenarios together form an abstract test suite. The abstract test suite is then used to create a corresponding executable test suite for execution on the SUT itself, in order to test the actual operation of the SUT, for comparison with the desired, intended or predicted operation of the SUT.

One known way of carrying out model-based testing is by using Markov chains. This technique, which is applicable in some cases, creates a model of the SUT as a finite state machine having an operational profile. A finite state machine (FSM) is a system which can exist in a finite number of different states. The operational profile is indicative of the statistical probability of the FSM being in each one of these different states. For example, the operational profile may comprise one or more statistical probabilities of the FSM making one or more transitions from a first one of the different states to a second one of the different states.

Test automation is yet another way of testing a computer program or system. This uses computer software, which is distinct from the computer program or system under test (SUT), to apply one or more test scenarios to the SUT and to compare the actual operation of the SUT as a result of these test scenarios with the desired, intended or predicted operation of the SUT.

Although static code analysis, model-based testing and test automation all represent improvements over traditional test techniques, it would still be desirable to provide a yet more improved method of testing a system which can accommodate agile methods of producing device software, and which can improve the reliability of electronic devices comprising device software produced using such agile methods.

### OBJECT OF THE INVENTION

An object of the present invention is therefore to provide a method of testing a system, a system test kit, an electronic device comprising a system tested according to such a method or using such a test kit, a method of manufacturing an electronic device, wherein the method of manufacture comprises such an effective method of testing a system, and a computer program product or program code or system for testing another system.

### DESCRIPTION OF THE INVENTION

The object of the invention is solved by a method of testing a system according to claim 1. The method at least comprises creating a model of the system under test, performing static code analysis on the system to generate one or more alerts, each respectively indicative of a respective error in the system under test, using the alerts to adapt the model of the system, using the adapted model of the system to generate a test suite, and executing the test suite thus generated on the system under test.

In other words, this method of testing a system takes the results of a static code analysis of the system and uses these results to adapt an a priori model of the system, before using the adapted model of the system for model-based testing of the system. This technique has the advantage that it allows a part or parts of the system which require more testing than others to be identified by the static code analysis, and for the execution of the test suite on the system to be concentrated on those parts of the system more than on the others. Thus, the chance of exposing any faults, bugs or errors in the system can be increased, whilst the total number of different test scenarios in the test suite and/or the time required for carrying out the model-based testing can both be reduced. In addition, the chance of exposing any faults, bugs or errors in the system can be increased without having to dig down into all parts of the system in detail.

The technical effects of this method of testing a system include that it renders an electronic device comprising such a system more reliable and less prone to faults or errors than if the system had not been subjected to such testing. The technical effects of this method also include that the time required for developing, testing and manufacturing an electronic device which comprises such a system can also be reduced, without reducing the device's reliability and with concomitant advantages for the cost of production of such a device.

Advantageous embodiments of the invention may be configured according to any claim and/or part of the following description.

Preferably, the model of the system under test is created as a Markov chain model, which models the system under test as a finite state machine (FSM) which can exist in a finite number of different states and which has an operational profile. The operational profile is indicative of the respective statistical probability of the finite state machine being in each one of the different states. The one or more alerts generated by the static code analysis are then used to adapt the operational profile of the finite state machine by changing a respective one or more of these statistical probabilities. If the operational profile comprises one or more statistical probabilities of the FSM making one or more transitions between the different states, the operational profile can be adapted by changing the respective probabilities of these state transitions on the basis of the alerts generated by the static code analysis.

If the model of the system under test is created as a Markov chain model, preferably, the statistical probability of the finite state machine being in one of the different states is changed in proportion to the number of alerts for that state. For example, suppose that the FSM has only two states. If the static code analysis of the system generates 4 alerts for a first one of these two states and 7 alerts for the second one of the two states, then according to this example, the model should be adapted so that the statistical probability of the finite state machine being in the first state and the statistical probability of the finite state machine being in the second state are placed in a ratio of 4:7 as well.

Preferably, the adapted model of the system comprises one or more test scripts. If so, the method preferably also comprises using at least one of the test scripts from the adapted model to generate the test suite, and executing the test suite on the system under test using test automation. This has the advantage that the entire test procedure may be carried out as an integrated whole, using static code analysis, model-based testing and test automation all together with each other, wherein the results of each one of these three different test techniques can be used in turn as the input for the next test technique.

If the system under test comprises a plurality of different modes of operation, the method preferably comprises creating a model of the system under test which comprises a plurality of different modules, each respectively corresponding to one of the different modes of operation of the system under test. If so, the method should then also comprise performing static code analysis on each of the modes of operation of the system under test to generate a respective number of alerts for each mode, generating the test suite by creating one or more test scenarios for each mode of operation of the system in dependence on the respective number of alerts for each mode, and executing the test suite on the system under test by running the test scenarios thus generated on the respective modes of operation of the system. The different modes of operation may, for example, be different functional modules of the system under test. If so, this allows those functional modules which are more prone to error to be identified by the static code analysis, and for the same more error-prone functional modules to be subjected to more test scenarios than those which have not been so identified.

Preferably, the method further comprises revising the system under test to correct one or more errors exposed by executing the test suite, and applying any of the aforementioned methods to the revised system as a regression test. Thus the method need not be applied just to newly developed systems or to systems previously tested using other methods, but can also be applied to a revised version of a system which has already previously been subjected to the same method of testing.

The present invention also relates to a system test kit. The system test kit at least comprises a static code analysis tool and a model-based test tool, wherein the static code analysis tool is configured to perform static code analysis on the system to generate an alert indicative of an error in the system under test and wherein the alert is used to adapt a model of the system under test, and wherein the model-based test tool is configured to generate a test suite from a model of the system thus adapted on the basis of the alert, for execution on the system under test.

Preferably, the system test kit further comprises a test automation tool configured to execute the test suite thus generated on the system under test.

The present invention further relates to an electronic device comprising a computer program, code, system or software tested according to a method according to any one of claims 1 to 7 or using a system test kit according to claim 8 or claim 9. The electronic device may be any one of a kitchen appliance, a washing machine, a dishwasher, a tumble dryer, a refrigerator, a freezer, a cooker, a lighting, heating, ventilation, air conditioning and/or hot water system, a water softener, a security system, a home entertainment system comprising at least one of a home cinema system and a hi-fi audio system, a television, an audio-visual device, a still or video camera, a portable navigation device, a games console, an ebook reader, a mobile phone, a vehicle control system, a medical device, a home automation system, a vending machine, an automatic teller machine and a sales checkout machine. In general, the electronic device may be any electronic device comprising embedded device software, sometimes also known as firmware, which is subject to continuous revision.

The present invention also relates to a method of manufacturing an electronic device, wherein the electronic device at least comprises a computer program, code, system or software and the method of manufacturing the electronic device at least comprises applying a method of testing a system according to any one of claims 1 to 7 to the computer program, code, system or software of the electronic device.

The present invention further relates to a computer program product or a program code or system for executing one or more than one of the herein described methods, or which embodies a system test kit according to claim 8 or claim 9.

Further features, goals and advantages of the present invention will now be described in association with the accompanying drawings, in which exemplary components of the invention are illustrated. Components of the devices and methods according to the invention which are at least essentially equivalent to each other with respect to their function can be marked by the same reference numerals, wherein such components do not have to be marked or described in all of the drawings.

In the following description, the invention is described by way of example only with respect to the accompanying drawings.

### BRIEF DESCRIPTION OF THE DRAWINGS

FIG. 1 is a schematic block diagram of a method of testing a system;

FIG. 2 is a schematic flow diagram of an embodiment of a method of testing a system;

FIG. 3 is a schematic diagram of a first model of a system under test; and

FIG. 4 is a schematic diagram of a second model of the same system under test as in FIG. 3.

### DETAILED DESCRIPTION

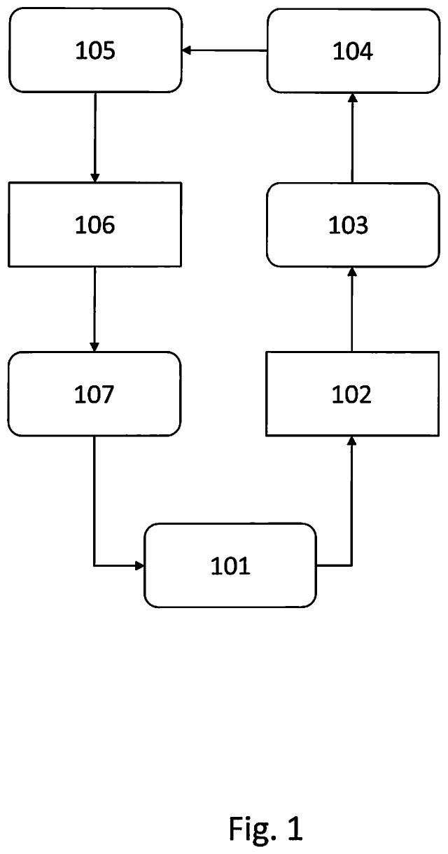

FIG. 1 schematically shows a block diagram of a method of testing a system. In FIG. 1, rectangular boxes with square corners denote artefacts and oblong boxes with round corners denote tools. Box 101 represents a system under test (SUT), such as a new version of a computer program, system or software for embedding in an electronic device (hereinafter referred to simply as “device software”). Box 102 represents a static code analysis tool for carrying out static code analysis on the device software 101. Box 103 represents the results of the static code analysis, which may be one or more alerts, each of which is respectively indicative of a respective error in the device software 101. Box 104, represents using the results of the static code analysis 103 to adapt a model of the SUT, for example by revising the statistical probabilities of one or more state transitions in the model of the SUT. Box 105 therefore represents the adapted model of the SUT. Box 106 represents a model-based testing tool for generating a suite of test scenarios. The model-based testing tool 106 therefore uses the adapted model 105 to generate a test suite 107, which is then executed on the system under test 101, in order to expose faults, bugs or errors in the device software.

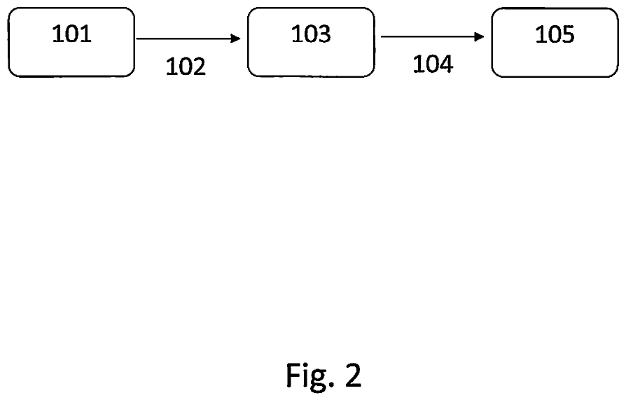

FIG. 2 schematically shows a flow diagram of an embodiment of a method of testing a system. Box 201 represents the performance of static code analysis on the system under test (SUT) by a static code analysis tool. Arrow 202 represents the results of the static code analysis, such as one or more alerts, each of which is respectively indicative of a respective error in the SUT. Box 203 represents adapting a model of the SUT according to the results 202 of the static code analysis. Arrow 204 represents a suite of test scenarios which are generated from the adapted model 203 by a model-based testing tool. Box 205 represents the subsequent execution of this test suite on the SUT by a test automation tool. This embodiment therefore represents a combination of three different types of testing technique in the same method of testing a system, namely, static code analysis, model-based testing and test automation.

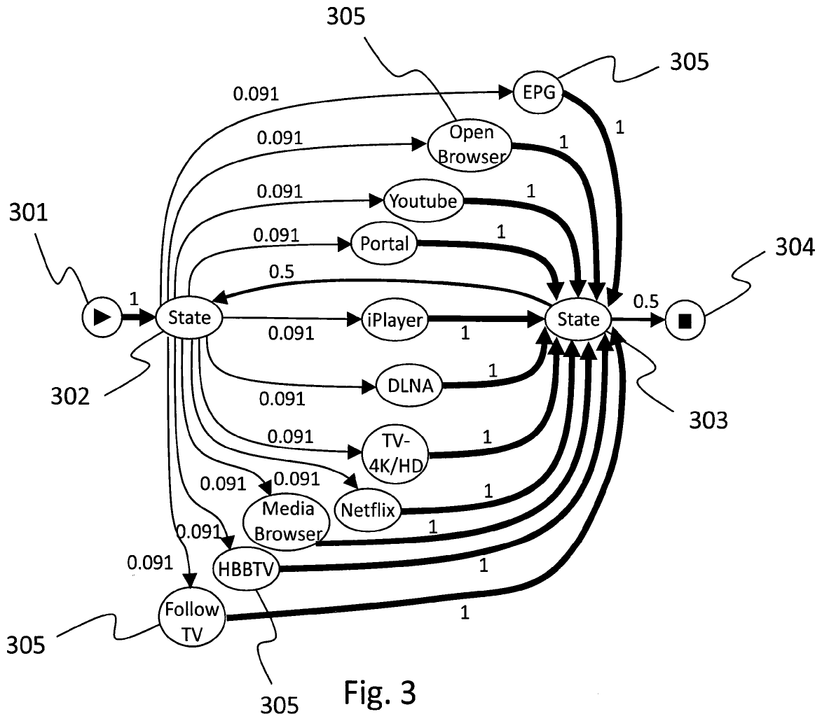

By way of example, FIG. 3 shows a model of a system under test, wherein the system under test is a so-called “smart” television system, that is to say, a television system which also comprises Internet connectivity. In this example, the smart television system has eleven different modes of operation. These are:
electronic programme guide (EPG);
open-source browser (OB);
YouTube™ (YT);
web portal, such as a web, internet or intranet portal (Portal);
BBC iPlayer™ (iPlayer);
Digital Living Network Alliance (DLNA);
4K high definition television broadcasts (TV-4K/HD);
Netflix™;
media browser (MB);
Hybrid Broadcast Broadband TV (HBBTV); and
a TV programme tracking app (FTV).

The model of the television system shown in FIG. 3 therefore also comprises eleven different modules, each of which respectively corresponds to one of the different modes of operation of the smart television system. The model is also a Markov chain model. Thus, the model is a finite state machine which has a start state 301 (shown at the left of FIG. 3), a mode selection state 302, a mode end state 303, and a stop state 304 (shown at the right of FIG. 3), as well as eleven other states 305, each of which corresponds to one of the eleven different modules of the model. The finite state machine also has an operational profile, so that in the model, statistical probabilities are assigned to each of the possible transitions between the different states. As can be seen in FIG. 3, the statistical probability assigned to the state transition from the start state 301 to the mode selection state 302 is 1. The statistical probabilities assigned to each of the state transitions from the mode selection state 302 to one of the eleven states 305, each of which corresponds to one of the eleven different modules of the model, are all initially set equal to each other at 1/11=0.0909 . . . . The statistical probabilities assigned to each of the state transitions from one of these eleven states 305 to the mode end state 303 are again all equal to 1. On the other hand, the statistical probability assigned to the state transition from the mode end state 303 back to the mode selection state 302 and from the mode end state 303 to the stop state 304 are also initially set equal to each other at 0.5. In other words, the model initially predicts that the system is equally likely to crash (i.e. reach stop state 304) as it is to operate as desired (i.e. return to mode selection state 302).

If a model-based testing tool, such as MaTeLo™, is applied to this model, it creates 10 test scenarios per mode of operation of the smart television system under test, which generates a test suite of 110 test scenarios in total, since the system under test has eleven modes of operation. Executing this test suite on the smart television system using a proprietary test automation tool developed by the applicant called VesTA was found to take approximately 5 hours and exposed two crash problems, one during a test of the YouTube™ mode of operation and one during a test of the DLNA mode of operation.

Static code analysis was then performed on each of the modes of operation of the system to generate a respective number of alerts for each mode. In this example, this generated a total of 106 alerts, which were distributed between the eleven different modes of operation of the system as follows:
EPG: 4
OB: 12
YT: 22
Portal: 22
iPlayer: 9
DLNA: 4
TV-4K/HD: 1
Netflix™: 8
MB: 3
HBBTV: 8
FTV: 13

These numbers of alerts for each mode of operation of the system were then used to adapt the operational profile in the model of the system by changing the statistical probabilities assigned to the state transitions from the mode selection state 302 to each of the eleven states 305 in proportion to the respective number of alerts, as follows:

Partial Probability of EPG=4/(4+12+22+22+9+4+1+8+3+8+13)=4/106=0.037
Partial Probability of OB=12/106=0.113
Partial Probability of YT=22/106=0.207
Partial Probability of Portal=22/106=0.207
Partial Probability of iPlayer=9/106=0.084
Partial Probability of DLNA=4/106=0.037
Partial Probability of TV-4K/HD=1/106=0.009
Partial Probability of Netflix™=8/106=0.075
Partial Probability of MB=3/106=0.028
Partial Probability of HBBTV=8/106=0.075
Partial Probability of FTV=13/106=0.122

In addition, the statistical probability assigned to the state transition from the mode end state 303 back to the mode selection state 302 was set equal to 0.99 and the statistical probability assigned to the state transition from the mode end state 303 to the stop state 304 was set equal to 0.01. In other words, the adapted model predicts that the system should only crash (i.e. reach stop state 304) 1% of the time and should operate as desired (i.e. return to mode selection state 302) 99% of the time.

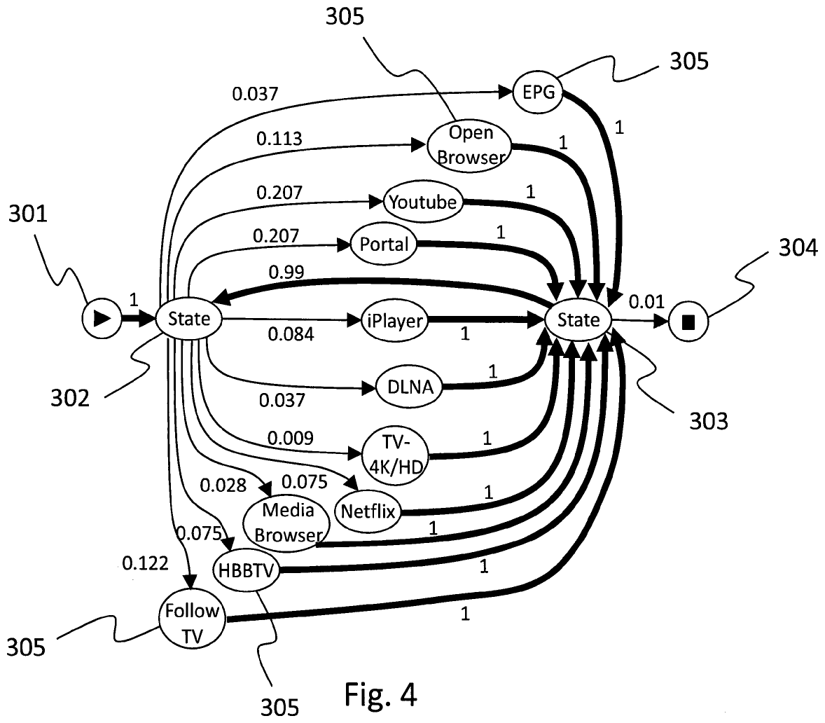

FIG. 4 shows all of these newly assigned statistical probabilities for the different state transitions of the adapted model. When the same model-based testing tool was applied to this adapted model, it generated a new test suite of 87 test scenarios in total instead. This total number of test scenarios was distributed between the modes of operation of the smart television system as follows:
EPG: 6
OB: 6
YT: 17
Portal: 6
iPlayer: 6
DLNA: 14
TV-4K/HD: 1
Netflix™: 6
MB: 13
HBBTV: 6
FTV: 6

Executing this new test suite on the smart television system using the same proprietary test automation tool as before was found to take approximately only three hours, but exposed a total of five errors, which caused the smart television system to reset itself during the YouTube™ mode of operation three times and during the Media Browser mode of operation twice. In other words, with this improved method, the test cycle took approximately 40% less time to complete (about three hours instead of about five hours), but exposed 150% more system errors (five errors instead of two errors). Hence critical errors can still be successfully exposed using this improved method, even though both the total number of test scenarios (87 instead of 110) and the total test time have been reduced.

Such a method of testing is applicable to any electronic device comprising embedded device software, often also known as firmware, which is subject to continuous and/or repeated revision. Thus whereas the concrete example described above relates to a smart television system, this method of testing is applicable to a wide range of different electronic devices, and especially to those which may be modelled as finite state machines.

The described methods have several technical effects which include making such electronic devices more reliable in their operation and less prone to faults or errors, as well as improving the speed and reducing the cost of their development, testing and manufacture.

In summary, therefore, the present invention provides a method of testing a system, such as a computer program, system or software which is embedded in an electronic device as firmware. The method at least comprises creating a model of the system under test, performing static code analysis on the system to generate one or more alerts, each respectively indicative of a respective error in the system under test, using the alerts to adapt the model of the system, using the adapted model of the system to generate a test suite, and executing the test suite thus generated on the system under test. The present invention also provides a corresponding test kit, which comprises a static code analysis tool and a model-based testing tool, wherein the model-based testing tool uses the results generated by the static code analysis tool. This system testing method and system test kit have the advantage of allowing a part or parts of the system under test which require more testing than others to be identified by the static code analysis, and for the execution of the test suite on the system to be concentrated on those parts of the system more than on the others. Thus, the chance of exposing any faults, bugs or errors in the system can be increased, whilst the length of the test cycle can be reduced.

Reference Numerals:

| | |
|---|---|
| 101 | Device software version |
| 102 | Static code analysis tool |
| 103 | Results of static code analysis (alerts) |
| 104 | Adapted state transition probabilities |
| 105 | Model |
| 106 | Model-based testing tool |
| 107 | Suite of test scenarios |
| 201 | Static code analysis |
| 202 | Results of static code analysis |
| 203 | Adapted model of system |
| 204 | Suite of test scenarios |
| 205 | Test automation |
| 301 | Start state |
| 302 | Mode selection state |
| 303 | Mode end state |
| 304 | Stop state |
| 305 | State corresponding to operational mode of system under test |

1. A method of testing a system, the method at least comprising:
creating a model of the system under test;
performing static code analysis on the system to generate one or more alerts, each of the one or more alerts being respectively indicative of a respective error in the system under test;
using the alerts to adapt the model of the system;
using the adapted model of the system to generate a test suite; and
executing the test suite thus generated on the system under test.

2. A method according to claim 1, comprising:
creating a model of the system under test as a Markov chain model, wherein the Markov chain model models the system under test as a finite state machine which can exist in a finite number of different states and which has an operational profile, the operational profile being indicative of the respective statistical probability of the finite state machine being in each one of the different states; and
using the one or more alerts to adapt the operational profile of the finite state machine by changing a respective one or more of the statistical probabilities.

3. A method according to claim 2, comprising changing the statistical probability of the finite state machine being in one of the different states in proportion to the number of alerts for that state.

4. A method according to claim 1, wherein the adapted model of the system comprises one or more test scripts and wherein the method comprises:
using at least one of the test scripts from the adapted model to generate the test suite; and
executing the test suite on the system under test using test automation.

5. A method according to claim 1, wherein the system under test comprises a plurality of different modes of operation and wherein the method comprises:
creating a model of the system under test which comprises a plurality of different modules, each module respectively corresponding to one of the different modes of operation of the system under test;
performing static code analysis on each of the modes of operation of the system under test to generate a respective number of alerts for each mode;
generating the test suite by creating one or more test scenarios for each mode of operation of the system in dependence on the respective number of alerts for each mode; and
executing the test suite on the system under test by running the test scenarios thus generated on the respective modes of operation of the system.

6. A method according to claim 1, further comprising:
revising the system to correct one or more errors exposed by executing the test suite; and
applying the method according to any one of the preceding claims to the revised system as a regression test.

7. A method according to claim 1, wherein the system under test is a computer program, code, system or software embedded in an electronic device.

8. A system test kit comprising:
a static code analysis tool; and
a model-based test tool;
wherein:
the static code analysis tool is configured to perform static code analysis on the system to generate an alert indicative of an error in the system under test and wherein the alert is used to adapt a model of the system under test; and
the model-based test tool is configured to generate a test suite from a model of the system thus adapted on the basis of the alert, for execution on the system under test.

9. A system test kit according to claim 8, further comprising a test automation tool configured to execute the test suite thus generated on the system under test.

10. An electronic device comprising a computer program, code, system or software tested according to a method according to claim 1.

11. An electronic device comprising a computer program, code, system or software tested using a system test kit according to claim 8.

12. An electronic device according to claim 10, wherein the electronic device is any one of a kitchen appliance, a washing machine, a dishwasher, a tumble dryer, a refrigerator, a freezer, a cooker, a lighting, heating, ventilation, air conditioning and/or hot water system, a water softener, a security system, a home entertainment system comprising at least one of a home cinema system and a hi-fi audio system, a television, an audio-visual device, a still or video camera, a portable navigation device, a games console, an ebook reader, a mobile phone, a vehicle control system, a medical device, a home automation system, a vending machine, an automatic teller machine and a sales checkout machine.

13. A method of manufacturing an electronic device, wherein the electronic device at least comprises a computer program, code, system or software and the method of manufacturing the electronic device at least comprises applying a method of testing a system according to claim 1 to the computer program, code, system or software.

14. A computer program product or a program code or system for executing one or more than one of the methods according to claim 1.

15. A computer program product or a program code or system embodying a system test kit according to claim 8.
